(19) United States
(12) Patent Application Publication
(10) Pub. No.: US 2021/0265613 A1
(43) Pub. Date: Aug. 26, 2021

(54) ALL-SOLID BATTERY INCLUDING A LITHIUM PHOSPHATE SOLID ELECTROLYTE WHICH IS STABLE WHEN IN CONTACT WITH THE ANODE

(71) Applicant: I-TEN, Champagne-au-Mont-d'Or (FR)

(72) Inventor: Fabien GABEN, Dardilly (FR)

(21) Appl. No.: 17/197,604

(22) Filed: Mar. 10, 2021

Related U.S. Application Data
(63) Continuation of application No. 15/323,676, filed on Jan. 3, 2017, now abandoned.

(51) Int. Cl. H01M 4/04; H01M 10/0525; H01M 10/0562; C01B 25/45; H01M 6/40; H01M 10/0585; H01M 4/485; H01M 4/505

(52) U.S. Cl. CPC H01M 4/0457; H01M 10/0525; H01M 10/0562; C01B 25/45; H01M 4/0421; H01M 6/40; C01P 2006/40; H01M 4/485; H01M 4/505; H01M 2300/0068; H01M 4/045; H01M 4/0409; H01M 10/0585

(57) ABSTRACT

A process for producing an all-solid, thin-layer battery, and an all-solid, thin-layer battery having materials used for electrolyte layers that are stable in contact with anodes and cathodes in order to improve the operation and lifetime of the batteries. The materials used for the electrolyte layers do not enable the formation of metallic lithium precipitates, or internal resistance at the interfaces with the electrodes.

### CROSS-REFERENCE TO RELATED APPLICATIONS

The present application is a continuation of U.S. patent application Ser. No. 15/323,676 (filed Jan. 3, 2017), which is a National Stage Application of PCT International Application No. PCT/FR2015/051801 (filed on Jul. 1, 2015), under 35 U.S.C. § 371, which claims priority to French Patent Application No. 1456250 (filed on Jul. 1, 2014), which are each hereby incorporated by reference in their respective complete entireties.

### TECHNICAL FIELD

This invention relates to the field of batteries and in particular lithium-ion batteries. It relates more specifically to all-solid lithium ion batteries (“Li-ion batteries”) and a novel process for producing such batteries.

### BACKGROUND

Modes of producing lithium-ion batteries (“Li-ion batteries”) presented in numerous articles and patents are known; the work “Advances in Lithium-Ion Batteries” (ed. W. van Schalkwijk and B. Scrosati), published in 2002 (Kluever Academic/Plenum Publishers) provides a good review of the situation. The electrodes of Li-ion batteries may be produced by means of printing or deposition techniques known to a person skilled in the art, and in particular by roll-coating, doctor blade or tape casting.

There are various architectures and chemical compositions of electrodes enabling Li-ion batteries to be produced. Recently, Li-ion batteries formed by all-solid thin layers have appeared. These batteries generally have a planar architecture, that is, they are essentially formed by a set of three layers forming a basic battery cell: an anode layer and a cathode layer separated by an electrolyte layer. More recently, Li-ion batteries with three-dimensional structures have been produced using new processes. Such processes are in particular disclosed in documents WO 2013/064 779 A1 or WO 2012/064 777 A1. In these documents, the production of anode, solid electrolyte and cathode layers is performed by electrophoresis. The batteries obtained by this process have a high power density; they also have a high energy density (around twice that of known lithium-ion batteries) due to the very low porosity level and the low thickness of the electrolyte films. In addition, the batteries obtained by these processes do not contain metallic lithium or organic electrolytes. Thus, they may be resistant when subjected to high temperatures. Finally, when they are produced in the form of a “microbattery”-type electronic component, they may then be tested before being welded to circuits, without the risk of damage, in particular when the batteries are in a partially charged or discharged state.

However, the performance of these all-solid batteries may be variable. Obtaining sustainable performance over time is dependent not only on the choice of the electrolytes and production parameters but also the overall architecture of the battery. For example, depending on the chemical composition and nature of the electrolyte film, internal resistance may appear at the interfaces with the electrodes.

Moreover, certain electrolytes disclosed in these documents are based on sulfides, which are stable within a broad potential range, but which have a tendency to create strong resistance to the transfer of charges at their interfaces with the electrodes. Furthermore, solid sulfide-based electrolytes are extremely hygroscopic, which may make it difficult to implement them on an industrial scale and may cause particular sensitivity to aging.

In addition, these documents disclose ionic conductive glass-based electrolytes, such as LiPON or lithiated borate. However, these have a relatively low glass transition temperature and are therefore capable of partially crystallizing during assembly of the battery by heat treatment; this causes their ionic conduction properties to deteriorate. Finally, these components remain relatively sensitive in contact with the atmosphere, making them difficult to implement on an industrial level.

Electrolytes containing lithiated phosphate-based materials are also known, the latter being stable in contact with the atmosphere and stable at high potential. However, these electrolytes are usually unstable in contact with anodes in lithium. The instability of these electrolytes in contact with anodes is essentially due to the presence of metallic elements capable of having multiple oxidation states that, when in contact with the low-potential anodes, will be reduced and change oxidation states. This chemical modification gradually renders the electrolyte electrically conductive, which degrades the performance of the battery.

This family of electrolytes includes Li₁₊ₓAlₓTi₂₋ₓ(PO₄)₃ (called LATP) in which a titanium reduction may appear at 2.4 V, and Li₁₊ₓAlₓGe₂₋ₓ(PO₄)₃ (called LAGP) in which a germanium reduction may appear at 1.8 V.

Aside from the electrochemical degradation of the electrolytes and other aging phenomena associated with the sensitivity to air of certain constituents of the Li-ion battery cell, the degradation of performance of Li-ion batteries may also come from the cathode. In fact, lithium insertion materials used to produce cathodes have reversible behavior only in a certain potential range. When the level of lithium inserted decreases below a certain threshold, crystallographic modifications may appear, causing irreversible losses in performance of the cathode materials. However, conventional Li-ion batteries as well as thin-layer Li-ion batteries using metallic lithium anodes have lithium ion storage capacities (at the anode level) greater than that at the cathode. In fact, in the case of batteries with metallic lithium anodes, the capacity of the anode is practically unlimited, and the lithium may be deposited onto the anode as it arrives. For standard Li-ion batteries using liquid electrolytes with lithium salts, an anode capacity lower than that of the cathode may lead to the formation of metallic lithium precipitates in the battery during charging. These precipitates form when the cathode produces lithium ions in excess of what the anode is capable of accepting. As the formation of metallic lithium precipitates in a battery cell is capable of causing a risk of thermal runaway, it is essential to ensure that the anodes have sufficient capacities to prevent the appearance of such a risk.

Although it is more of a safety measure, this architecture may in some cases lead to an extraction of too many lithium ions from the cathode, in particular during high-power cycling phases on charged batteries. This may irreversibly deteriorate the insertion capacity of the battery and lead to its aging.

In addition, the aging of the battery and the loss of its capacity may also result from the precipitation of lithium ions in the porosities of the electrodes, thereby reducing the quantity of lithium ions available for operation of the battery, as well as the loss of contacts between the electrode particles.

### SUMMARY

A first objective of the present invention is to produce all-solid thin-layer batteries, in which the materials used for the electrolyte layers are stable in contact with anodes and cathodes in order to improve the operation and lifetime of said batteries.

Yet another objective is to produce all-solid thin-layer batteries in which the materials used for the electrolyte layers do not enable the formation of metallic lithium precipitates, or internal resistance at the interfaces with the electrodes.

Another objective of the invention is to produce thin-layer batteries by a process capable of being implemented on an industrial level in a relatively simple manner.

A first object of the invention concerns a process for producing an all-solid thin-layer battery including the following series of steps:

a) a layer including at least one anode material (referred to here as “anode material layer”) is deposited on its conductive substrate, preferably selected from the group formed by a metal sheet, a metal strip, a metallized insulating sheet, a metallized insulating strip, a metallized insulating film, said conductive substrates, or conductive elements thereof, capable of serving as an anode current collector;

b) a layer including at least one cathode material (referred to here as “cathode material layer”) is deposited on its conductive substrate, preferably selected from the group formed by a metal sheet, a metal strip, a metallized insulating sheet, a metallized insulating strip, a metallized insulating film, said conductive substrates, or conductive elements thereof, capable of serving as a cathode current collector, with the understanding that steps a) and b) can be reversed;

c) on the layer obtained in step a) and/or b), a layer including at least one solid electrolyte material (referred to here as “electrolyte material layer”) is deposited, chosen from:
Li₃(Sc₂₋ₓMₓ)(PO₄)₃ with M=Al or Y and 0≤x≤1; or
Li₁₊ₓMₓ(Sc)₂₋ₓ(PO₄)₃ with M=Al, Y, Ga or a mixture of the three compounds and 0≤x≤0.8; or
Li₁₋ₓMₓ(Ga_{1-y}Sc_{y})₂₋ₓ(PO₄)₃ with 0≤x≤0.8; 0≤y≤1 and M=Al or Y; or a mixture of the two compounds; or
Li₁₊ₓMₓ(Ga)₂₋ₓ(PO₄)₃ with M=Al, Y; or a mixture of the two compounds and 0≤x≤0.8; or
Li_{3+y}(Sc₂₋ₓMₓ)Q_{y}P_{3-y}O₁₂ with M=Al and/or Y and Q=Si and/or Se, 0≤x≤0.8 and 0≤y≤1; or
Li1+x+yMxSc2−xQyP3−yO12 with M=Al, Y, Ga or a mixture of the three compounds and Q=Si and/or Se, 0≤x≤0.8 and 0≤y≤1; or
Li1+x+y+zMx(Ga1−yScy)2−xQzP3−zO12 with 0≤x≤0.8; 0≤y≤1; 0≤z≤0.6 with M=Al or Y or a mixture of the two compounds and Q=Si and/or Se;
Li1+xNxM2−xP3O12 with 0≤x≤1 and N=Cr and/or V, M=Sc, Sn, Zr, Hf, Se or Si, or a mixture of these compounds;

d) the following are stacked, layer upon layer, in series:
a layer including at least one anode material coated with a layer including at least one electrolyte material obtained in step c) with a layer including at least one cathode material coated or not with a layer including at least one electrolyte material obtained in step c);
or a layer including at least one cathode material coated with a layer including at least one electrolyte material obtained in step c) with a layer including at least one anode material coated or not with a layer including at least one electrolyte material obtained in step c);

e) a heat treatment and/or a mechanical compression of the stack obtained in step d) is carried out in order to obtain an all-solid thin-layer battery.

In a particular embodiment of the process according to the invention, when a layer of electrolyte material is deposited on the layer obtained in step a), a layer of at least one material chosen from the following is optionally deposited on the layer obtained in step b):
Li3(Sc2−xMx)(PO4)3 with M=Al or Y and 0≤x≤1; or
Li1+xMx(Sc)2−x(PO4)3 with M=Al, Y, Ga or a mixture of two or three compounds and 0≤x≤0.8; or
Li1+xMx(Ga1−yScy)2−x(PO4)3 with 0≤x≤0.8; 0≤y≤1 and M=Al or Y; or a mixture of the two compounds; or
Li1+xAlxTi2−x(PO4)3 with 0≤x≤1; or
Li1+xAlxGe2−x(PO4)3 with 0≤x≤1; or
Li1+x+zMx(Ge1−yTiy)2−xSizP3−zO12 with 0≤x≤0.8; 0≤y≤1; 0≤z≤0.6 and M=Al, Ga or Y or a mixture of two or three of these compounds; or
Li3+y(Sc2−xMx)QyP3−yO12, with M=Al and/or Y and Q=Si and/or Se, 0≤x≤0.8 and 0≤y≤1; or
Li1+x+yMxSc2−xQyP3−yO12 with M=Al, Y, Ga or a mixture of the three compounds and Q=Si and/or Se, 0≤x≤0.8 and 0≤y≤1; or
Li1+x+y+zMx(Ga1−yScy)2−xQzP3−zO12 with 0≤x≤0.8; 0≤y≤1; or 0≤z≤0.6 with M=Al or Y or a mixture of the two compounds and Q=Si and/or Se;
Li1+xNxM2−xP3O12 with 0≤x≤1 and N=Cr and/or V, M=Sc, Sn, Zr, Hf, Se or Si or a mixture of these compounds.

According to the invention, the layers including at least one anode material, at least one cathode material and at least one solid electrolyte material are deposited by one or more techniques selected from the following techniques: (i) physical vapor deposition (PVD), and more specifically by vacuum evaporation, laser ablation, ion beam, or cathode sputtering; (ii) chemical vapor deposition (CVD), and more specifically plasma-enhanced chemical vapor deposition (PECVD), laser-assisted chemical vapor deposition (LACVD), or aerosol-assisted chemical vapor deposition (AA-CVD); (iii) electrospraying; (iv) electrophoresis; (v) aerosol deposition; (vi) sol-gel; and (vii) dipping, more specifically dip-coating, spin-coating or the Langmuir-Blodgett process.

Advantageously, said anode and/or cathode and/or electrolyte layers are produced by deposition of nanoparticles, respectively, of anode, cathode or electrolyte material, by one or more techniques selected from the following techniques: electrospraying, electrophoresis, aerosol deposition, and dipping.

Preferably, the anode, cathode and electrolyte layers are all deposited by electrophoresis, preferably from nanoparticles of cathode material(s), electrode material(s) and anode material(s).

According to the invention, the anode material layer a) is produced from material chosen from the following:

(i) tin oxynitrides (typical formula SnOxNy);

(ii) lithiated iron phosphate (typical formula LiFePO4);

(iii) mixed silicon and tin oxynitrides (typical formula SiaSnbOyNz with a>0, b>0, a+b≤2, 0<y≤4, 0<z≤3) (also called SiTON), and in particular SiSn0.87O1.2N1.72; as well as oxynitrides in the form SiaSnbCcOyNz with a>0, b>0, a+b≤2, 0<c<10, 0<y<24, 0<z<17; SiaSnbCcOyNzXn with Xn at least one of the elements among F, Cl, Br, I, S, Se, Te, P, As, Sb, Bi, Ge, Pb and a>0, b>0, a+b>0, a+b≤2, 0<c<10, 0<y<24 and 0<z<17; and SiaSnbOyNzXn with Xn at least one of the elements among F, Cl, Br, I, S, Se, Te, P, As, Sb, Bi, Ge, Pb and a>0, b>0, a+b≤2, 0<y≤4 and 0<z≤3;

(iv) nitrides of type SixNy (in particular with x=3 and y=4), SnxNy (in particular with x=3 and y=4), ZnxNy (in particular with x=3 and y=4), Li3−xMxN (with M=Co, Ni, Cu);

(v) the oxides SnO2, Li4Ti5O12, SnB0.6P0.4O2.9 and TiO2.

According to the invention, the cathode material layer b) is produced from cathode material chosen from:

(i) the oxides LiMn2O4, LiCoO2, LiNiO2, LiMn1.5Ni0.5O4, LiMn1.5Ni0.5−xXxO4 (in which X is selected from Al, Fe, Cr, Co, Rh, Nd, other rare earth elements, and in which 0<x<0.1), LiFeO2, LiMn1/3Ni1/3Co1/3O4;

(ii) the phosphates LiFePO4, LiMnPO4, LiCoPO4, LiNiPO4, Li3V2(PO4)3; the phosphates of formula LiMM′P04, with M and M′ (M≠M′) selected from Fe, Mn, Ni, Co, V;

(iii) all lithiated forms of the following chalcogenides: V2O5, V3O8, TiS2, titanium oxysulfides (TiOySz), tungsten oxysulfides (WOySz), CuS, CuS2.

In a particular embodiment of the process according to the invention, the anode and/or cathode material layers also include electrically conductive materials, in particular graphite, and/or nanoparticles of lithium ion conductive materials, of the type used to produce electrolyte films, or cross-linked solid polymer materials comprising ionic groups.

Advantageously, the heat treatment step e) is performed at a temperature of between 200° C. and 1000° C., preferably between 300° C. and 700° C., and even more preferably between 300° C. and 500° C., and/or the mechanical compression is performed at a pressure of between 10 and 400 MPa, preferably between 20 and 100 MPa.

In a particular embodiment, the process according to the invention also includes a step f) of encapsulation of the battery obtained in step e) by deposition of at least one layer of ceramic, vitreous or vitroceramic encapsulation material.

Advantageously, at least two faces of the battery obtained in step f) are cut so as to expose only the cathode sections on the first cutting plane and only the anode sections on the second cutting plane.

Preferably, anode and cathode terminals are produced by metallization of the sections cut, preferably by deposition of a tin layer, optionally deposited on a sub-layer of nickel and/or epoxy resin filled with metal particles.

In a particular embodiment according to the invention, a heat treatment is performed at a temperature of between 300° C. and 1000° C., preferably between 400° C. and 800° C., and even more preferably between 500° C. and 700° C. in order to recrystallize the anode and/or cathode materials, said heat treatment being performed after step a) and/or b) but before step c) of deposition of the electrolyte layers.

Advantageously, the size of the electrolyte material nanoparticles is smaller than 100 nm, and preferably smaller than 30 nm.

According to the invention, the encapsulation step f) is performed by chemical vapor deposition (CVD), and more specifically plasma-enhanced chemical vapor deposition (PECVD), or by plasma-spray chemical vapor deposition (PSCVD).

In a particular embodiment according to the invention, step f) of encapsulation of the battery obtained in step e) is performed by deposition of two ceramic, vitreous or vitroceramic material encapsulation layers. Advantageously, the first encapsulation layer is performed by atomic layer deposition (ALD), preferably of an atomic layer of an oxide of type Al2O3 or Ta2O3 or of other oxides. This first layer provides full coverage and protects the battery from the external environment. The second encapsulation layer may be produced by chemical vapor deposition (CVD), and more specifically plasma-enhanced chemical vapor deposition (PECVD) or by plasma-spray chemical vapor deposition (PSCVD) of ceramic, vitreous or vitroceramic material.

According to the invention, the conductive substrates are made of aluminum, copper, stainless steel or nickel, preferably nickel, and optionally coated with a noble metal chosen from the following metals: gold, platinum, palladium, vanadium, cobalt, nickel, manganese, niobium, tantalum, chromium, molybdenum, titanium, palladium, zirconium, tungsten or any alloy containing at least one of these metals.

Another object of the invention concerns a battery capable of being obtained by the process according to the invention.

Advantageously, the surface capacity of the cathode is greater than or equal to the surface capacity of the anode.

In a preferred embodiment, the stack of cathode and anode layers is laterally offset.

Advantageously, the battery includes at least one encapsulation layer, preferably a ceramic, glass or vitroceramic layer. Even more advantageously, the battery includes a second encapsulation layer deposited on said first encapsulation layer, said second encapsulation layer preferably being silicone or hexamethyldisiloxane (HDMSO).

Preferably, said at least one encapsulation layer entirely covers four of the six faces of said battery and partially covers the two remaining faces, located below the metallizations intended for the connection of the battery.

In a particular embodiment, the battery includes terminals where, respectively, the cathode and the anode current collectors are exposed.

Advantageously, the anode connections and the cathode connections are located on opposite sides of the stack.

According to a particular aspect of the invention, the battery is entirely inorganic.

### DRAWINGS

FIG. 1 shows the charge and discharge curves obtained with this battery.

FIG. 2 shows the change in the capacity of the battery thus produced during cycling.

### DESCRIPTION

In the context of the present invention, “electrophoretic deposition” or “deposition by electrophoresis” refers to a layer deposited by a process of depositing particles previously suspended in a liquid medium, onto a preferably conductive substrate, the displacement of the particles to the surface of the substrate being generated by application of an electric field between two electrodes placed in the suspension, one of the electrodes constituting the conductive substrate on which the deposition is performed, and the other electrode (“counter electrode”) being placed in the liquid phase. A so-called “dense” deposition of particles forms on the substrate, if the zeta potential of the particle suspension has an appropriate value, and/or after a specific thermal and/or mechanical densification treatment. This deposition has a particular structure recognizable to a person skilled in the art, who can distinguish it from depositions obtained by any other technique.

In the context of the present document, the size of a particle is its largest dimension. Thus, a “nanoparticle” is a particle of which at least one of the dimensions is smaller than 100 nm. The “particle size” or “mean particle size” of a powder or a group of particles is given as D50.

An “all-solid” battery is a battery not containing liquid phase material.

The “surface capacity” of an electrode refers to the quantity of lithium ion capable of being inserted into an electrode (expressed as mA·h/cm2).

The present invention is intended to provide improvements to the batteries disclosed in applications WO 2013/064 779 A1 or WO 2012/064 777 A1, in order to improve the production, the temperature behavior and the lifetime thereof. To this end, the inventor has developed a new process for producing an all-solid multilayer-structure battery, not containing organic solvents or metallic lithium, so that they can be heated without risk of combustion. The batteries obtained by the process according to the invention have a multilayer structure, by contrast with the planar structures of conventional batteries, in order to obtain batteries having good energy and power density.

The solid anode, cathode and electrolyte layers are deposited using at least one of the following techniques: (i) physical vapor deposition (PVD), and more specifically vacuum evaporation, laser ablation, ion beam, cathode sputtering; (ii) chemical vapor deposition (CVD), and more specifically plasma-enhanced chemical vapor deposition (PECVD), laser-assisted chemical vapor deposition (LACVD), or aerosol-assisted chemical vapor deposition (AA-CVD); (iii) electrospraying; (iv) electrophoresis; (v) aerosol deposition; (vi) sol-gel; AND (vii) dipping, more specifically dip-coating, spin-coating or the Langmuir-Blodgett process.

In a particular embodiment, the solid anode, cathode and electrolyte layers are all deposited by electrophoresis. The electrophoretic deposition of particles is performed by applying an electric field between the substrate on which the deposition is produced and a counter electrode, enabling the charged particles of the colloidal suspension to move and be deposited on the substrate. The absence of binders and other solvents deposited at the surface with the particles makes it possible to obtain very compact depositions. The compactness obtained owing to the electrophoretic deposition limits the risks of cracks or the appearance of other defects in the deposition during the drying steps. In addition, the deposition rate may be high owing to the electric field applied and the electrophoretic mobility of the particles of the suspension.

The process for producing an all-solid battery includes a step a) of deposition of an anode material layer. The anode material layer is preferably produced by electrophoresis. The materials chosen for the anode material layer are preferably chosen from the following materials:

(i) tin oxynitrides (typical formula SnOxNy);

(ii) lithiated iron phosphate (typical formula LiFePO4);

(iii) mixed silicon and tin oxynitrides (typical formula SiaSnbOyNz with a>0, b>0, a+b≤2, 0<y≤4, 0<z≤3) (also called SiTON), and in particular SiSn0.87O1.2N1.72; as well as oxynitrides in the form SiaSnbCcOyNz with a>0, b>0, a+b≤2, 0<c<10, 0<y<24, 0<z<17; SiaSnbCcOyNzXn with Xn at least one of the elements among F, Cl, Br, I, S, Se, Te, P, As, Sb, Bi, Ge, Pb and a>0, b>0, a+b>0, a+b≤2, 0<c<10, 0<y<24 and 0<z<17; and SiaSnbOyNzXn with Xn at least one of the elements among F, Cl, Br, I, S, Se, Te, P, As, Sb, Bi, Ge, Pb and a>0, b>0, a+b≤2, 0<y≤4 and 0<z≤3;

(iv) nitrides of type SixNy (in particular with x=3 and y=4), SnxNy (in particular with x=3 and y=4), ZnxNy (in particular with x=3 and y=4), Li3−xMxN (with M=Co, Ni, Cu);

(v) the oxides SnO2, Li4Ti5O12, SnB0.6P0.4O2.9 and TiO2.

Li4T5O12 for producing the anode layer is particularly preferred. In addition, Li4T5O12 is a lithium insertion material reversibly inserting lithium ions without causing deformation of the host material.

In another particular embodiment, LiFePO4 is preferred. In fact, the anode layer may also be produced by any material with a lithium insertion potential below the insertion potential of the material used to produce the cathode layer. For example, LiFePO4 may be used as an anode material when LiMn1.5Ni0.5O4 is used as the cathode material.

According to the invention, the process for producing an all-solid battery includes a step b) of depositing a cathode material layer. The cathode material layer is preferably produced by electrophoresis. The materials chosen for the cathode material layer are preferably chosen from the following materials:

(i) the oxides LiMn2O4, LiCoO2, LiNiO2, LiMn1.5Ni0.5O4, LiMn1.5Ni0.5−xXxO4 (in which X is selected from Al, Fe, Cr, Co, Rh, Nd, other rare earth elements, and in which 0<x<0.1), LiFeO2, LiMn1/3Ni1/3Co1/3O4;

(ii) the phosphates LiFePO4, LiMnPO4, LiCoPO4, LiNiPO4, Li3V2(PO4)3;

(iii) all lithiated forms of the following chalcogenides: V2O5, V3O8, TiS2, titanium oxysulfides (TiO_{y}S_{z}), tungsten oxysulfides (WO_{y}S_{z}), CuS, CuS₂.

In a preferred embodiment, the cathode electrode consists of a thin layer of LiMn₂O₄ or LiMn_{1.5}Ni_{0.5}O₄, which is deposited on a metal substrate, preferably nickel. This material has the advantage of not requiring vacuum deposition techniques, and of not requiring dry-room depositions, i.e. in a dry and clean atmosphere. In fact, LiMn₂O₄, like LiMn_{1.5}Ni_{0.5}O4, are not spontaneously sensitive to air. The impact of the exposures of cathode materials to air during production of the electrodes remains negligible with regard to the relatively short implementation times.

To produce the anode or cathode, it is possible to add to the above-cited nanoparticles of electrically conductive materials, and in particular graphite, and/or nanoparticles of ionic conductive materials, or polymer-based ionic conductors comprising ionic groups. Preferably, the ionic groups are chosen from the following cations: imidazolium, pyrazolium, tetrazolium, pyridinium, pyrrolidinium, such as n-propyl-n-methylpyrrolidinium (also called PYR13) or n-butyl-n-methylpyrrolidinium (also called PYR14), ammonium, phosphonium or sulfonium; and/or among the following anions: bis(trifluoromethane)sulfonamide, bis(fluorosulfonyl)imide, or n-(nonafluorobutanesulfonyl)-n-(trifluoromethanesulfonyl)-imide (with a raw formula C5F12NO4S2, also called IM14-).

Advantageously, the depositions of the anode and cathode material layer are performed by an electrophoretic deposition of anode and cathode material nanoparticles, respectively.

Advantageously, the depositions of the layer of anode and cathode material nanoparticles are performed directly on the metal substrate. For small nanoparticle sizes, i.e. smaller than 100 nm, and preferably smaller than 50 nm, the deposition of anode, cathode and electrolyte layers are performed by electrospraying, electrophoresis, aerosol deposition, or dipping. Advantageously, the anode, cathode and electrolyte layers are all deposited by electrophoresis. This particular embodiment of the process according to the invention makes it possible to obtain a dense and compact layer of nanoparticles, in particular by self-sintering of the nanoparticle layer during the step of electrophoretic deposition, drying and/or heat treatment at low temperature. In addition, as the electrophoretic deposition of the layer of anode or cathode material nanoparticles is compact, the risk of cracking of the layer after drying is reduced, unlike the nanoparticle layers produced from inks or fluids, having low dry extract contents and for which the deposits contain large quantities of solvent, which, after drying leads to the appearance of cracks in the deposit, which is detrimental to the operation of a battery.

According to the invention, the deposition of the layer of anode or cathode material nanoparticles is performed directly on its conductive substrate, preferably a metal conductive substrate chosen from the following materials: nickel, aluminum or copper. In a preferred embodiment, the deposition of the layer of anode or cathode material nanoparticles is performed on a nickel substrate. The thickness of the substrate is less than 10 μm, and preferably less than 5 μm.

The conductive substrates may be used in the form of sheets, optionally sheets including pre-cut electrode patterns or in the form of strips. To improve the quality of the electrical contacts with the electrodes, the substrates may advantageously be coated with a metal or a metal alloy, preferably chosen from gold, chromium, stainless steel, palladium, molybdenum, titanium, tantalum or silver.

According to the invention, the deposition of a layer of anode or cathode material nanoparticles directly onto its conductive substrate, for example, by electrophoresis, makes it possible to obtain a dense nanocrystalline structure layer. However, the formation of grain boundaries is possible, leading to the formation of a layer having a particular structure, between that of an amorphous and crystallized material, which may limit the kinetics of diffusion of the lithium ions in the thickness of the electrode. Thus, the power of the battery electrode and the life cycle may be affected. Advantageously, to improve the performance of the battery, a recrystallization heat treatment is performed in order to improve the crystallinity, and optionally the consolidation of the electrode is performed in order to reinforce the power of the electrodes (anode and/or cathode).

The recrystallization heat treatment of the anode and/or cathode layer is performed at a temperature of between 300° C. and 1000° C., preferably between 400° C. and 800° C., and even more preferably between 500° C. and 700° C. The heat treatment must be performed after step a) and/or b) of deposition of the anode and/or cathode layer, but before step c) of deposition of the layer of electrolyte nanoparticles.

According to the invention, the process for producing a battery includes a step c) of deposition of an electrolyte material layer. The deposition of the electrolyte material layer is performed on the anode material layer and/or on the cathode material layer. The deposition of a solid electrolyte layer on the anode or cathode layer makes it possible to protect the electrochemical cell from an internal short-circuit. It also makes it possible to produce an all-solid battery with a long lifetime, and which is easy to produce. The deposition of the electrolyte material layer is preferably performed by electrophoresis.

More specifically, the materials chosen as electrolyte materials are preferably chosen from the following materials:
on the anode material layer obtained at step a) and/or b):
Li3(Sc2−xMx)(PO4)3 with M=Al or Y and 0≤x≤1; or
Li1+xMx(Sc)2−x(PO4)3 with M=Al, Y, Ga or a mixture of two or three compounds and 0≤x≤0.8; or
Li1+xMx(Ga)2−x(PO4)3 with M=Al, Y or a mixture of the two compounds M and 0≤x≤0.8; or
Li1+xMx(Ga1−yScy)2−x(PO4)3 with 0≤x≤0.8; 0≤y≤1.0 and M=Al or Y; or a mixture of the two compounds; or
Li3+y(Sc2−xMx)QyP3−yO12, with M=Al and/or Y and Q=Si and/or Se, 0≤x≤0.8 and 0≤y≤1; or
Li1+x+yMxSc2−xQyP3−yO12 with M=Al, Y, Ga or a mixture of the three compounds and Q=Si and/or Se, 0≤x≤0.8 and 0≤y≤1; or
Li1+x+y+zMx(Ga1−yScy)2−xQzP3−zO12 with 0≤x≤0.8; 0≤y≤1; or 0≤z≤0.6 with M=Al or Y or a mixture of the two compounds and Q=Si and/or Se;
Li1+xNxM2−xP3O12 with 0≤x≤1 and N=Cr and/or V, M=Sc, Sn, Zr, Hf, Se or Si or a mixture of these compounds.

In a preferred embodiment of the process according to the invention, when a layer of electrolyte material is deposited on the layer obtained in step a), it is possible optionally to deposit onto the layer obtained in step b) a layer of at least one material chosen from the following:
Li3(Sc2−xMx)(PO4)3 with M=Al or Y and 0≤x≤1; or
Li1+xMx(Sc)2−x(PO4)3 with M=Al, Y, Ga or a mixture of two or three compounds and 0≤x≤0.8; or
Li1+xMx(Ga)2−x(PO4)3 with M=Al, Y or a mixture of the two compounds M and 0≤x≤0.8; or
Li1+xMx(Ga1−yScy)2−x(PO4)3 with 0≤x≤0.8; 0≤y≤1.0 and M=Al or Y; or a mixture of the two compounds; or
Li1+xAlxTi2−x(PO4)3 with 0≤x≤1; or
Li1+xAlxGe2−x(PO4)3 with 0≤x≤1; or
Li1+x+zMx(Ge1−yTiy)2−xSizP3−zO12 with 0≤x≤0.8 and 0≤y≤1.0 and 0≤z≤0.6 and M=Al, Ga or Y or a mixture of two or three of these compounds; or
Li3+y(Sc2−xMx)QyP3−yO12, with M=Al and/or Y and Q=Si and/or Se, 0≤x≤0.8 and 0≤y≤1; or
Li1+x+yMxSc2−xQyP3−yO12 with M=Al, Y, Ga or a mixture of the three compounds and Q=Si and/or Se, 0≤x≤0.8 and 0≤y≤1; or
Li1+x+y+zMx(Ga1−yScy)2−xQzP3−zO12 with 0≤x≤0.8; 0≤y≤1; 0≤z≤0.6 with M=Al or Y or a mixture of the two compounds and Q=Si and/or Se;
Li1+xNxM2−xP3O12 with 0≤x≤1 and N=Cr and/or V, M=Sc, Sn, Zr, Hf, Se or Si or a mixture of these compounds.

Other electrolytic materials based on scandium may also be suitable, even if they do not belong to the general formula above. It is possible to cite, in particular, chemical compositions of types Li3Sc2(PO4)3 or Li4.8Sc1.4(PO4)3.

Solid lithiated phosphate-based electrolytes are stable in contact with the atmosphere and stable at high potential, making the industrial-scale battery production easier. The stability of these electrolytes also helps to confer on the resulting battery good lifetime performance. Finally, lithiated phosphate-based electrolytes create few resistive effects at the interfaces with the electrodes and may be used in the production of “all-solid” batteries, in particular with cathodes functioning at high voltages, such as, for example 5V cathodes of the LiMn1.5Ni0.5O4 type.

In addition, lithiated phosphate-based materials have a low melting temperature, with respect to the materials conventionally used in Li-ion batteries, allowing for assemblies of all-solid cells by “diffusion bonding” and/or by low-temperature sintering.

The electrolyte layer deposited by the process according to the invention includes solid materials of the lithiated phosphate type, the latter being stable over time in contact with anodes and also stable in contact with the atmosphere. In addition, the solid electrolyte layer in contact with the anode does not include metal ions capable of being reduced in contact with anodes. Thus, the solid electrolyte layer deposited by the process according to the invention includes at least scandium and/or gallium-based materials. In addition, scandium and gallium have only one oxidation state and therefore do not risk changing oxidation states in contact with the anode and/or cathode. Also, the solid lithiated phosphate-based electrolyte, doped with scandium and/or gallium, is both a good ionic conductor and stable over time in contact with the battery electrodes.

Advantageously, the solid electrolyte layer is produced by electrophoretic deposition of electrolyte material nanoparticles, which are electrically insulating. The layers obtained provide full coverage, without localized defects. The current deposition densities are concentrated on the less insulating zones, in particular localized where a defect may be present.

The absence of defects in the electrolyte layer prevents the appearance of creeping short-circuits, excessive self-discharges, or even failure of the battery cell.

The electrophoretic deposition technique also makes it possible to obtain dense layers of electrode and/or electrolyte materials. When the size of the particles to be deposited is smaller than 100 nm, preferably smaller than 50 nm, and even more preferably smaller than 30 nm, it is possible to obtain dense layers by electrophoresis directly on the metal conductive substrates, with a density greater than 50% of the theoretical density of the massive body. To prevent cracking of the layers after deposition, the nanoparticles placed in suspension must be small and perfectly stable. According to the properties of the nanoparticles deposited, the compactness, the thickness of the layers, an additional heat and/or mechanical treatment may be performed in order to densify the deposits of said layers during the assembly step. This may lead to densities greater than 85% or even greater than 90% of the theoretical density of the massive body.

For the deposition by electrophoresis of a suspension of nanoparticles smaller than 100 nm, preferably smaller than 50 nm and even more preferably smaller than 30 nm, the layers obtained may be dense directly after deposition, in particular when the materials deposited are non-refractory and have a high surface energy. The consolidation of the thin layer just after deposition has the advantage of considerably reducing the heat treatment, which may lead to interdiffusion phenomena at the interfaces between the electrodes and the electrolyte film, or to the formation of new chemical compounds capable of being highly resistive to the diffusion of lithium ions.

According to a particular embodiment of the process of the invention, the electrodes (anode and cathode) are “punched” according to a cutting pattern in order to produce cuts with the dimensions of the battery to be produced. These patterns include three cuts that are adjoined (for example in a U shape), and which define the dimension of the battery. A second slot may be produced on the non-cut side in order to make it possible to ensure that products necessary for encapsulation of the component can pass. The anode and cathode electrodes are then stacked alternately in order to form a stack of a plurality of basic cells. The anode and cathode cutting patterns are placed in a “head-to-tail” configuration.

In another particular embodiment of the process according to the invention, the electrodes are cut before step c) of deposition of the electrolyte layer(s), enabling the electrode edges to be covered by an electrolyte film, thus protecting the electrodes from contact with the atmosphere, and enabling the lifetime of the battery to be improved. In an alternative embodiment, the cuts are produced on the substrates before steps a) and b) of deposition of the anode and cathode layer, enabling the electrode edges to be covered by an electrolyte film. This particular embodiment has the advantage of covering the electrode edges before the layer of electrolyte material nanoparticles is deposited, thereby enabling an encapsulation film to be easily produced around the electrodes, in particular when the electrolyte layer is comprised of moisture-stable materials. The covering of the lateral edges of the electrodes also makes it possible to reduce the risks of short circuit in the cell.

Finally, an essential step of the process according to the invention includes a heat treatment and/or mechanical compression of the stack obtained above in order to obtain an all-solid thin-layer battery.

The heat treatment is performed at a temperature of between 200 and 1000° C., preferably 300 and 700° C., and even more preferably between 300 and 500° C. Advantageously, the temperature of the heat treatment does not exceed 600° C.

Advantageously, the mechanical compression of the layers to be assembled is performed at a pressure of between 10 and 400 MPa, and preferably between 20 and 100 MPa.

In a particular embodiment, it is advantageous, after the step of stacking and before the addition of terminals, to encapsulate the stack by depositing a thin encapsulation layer in order to ensure the protection of the battery cell from the atmosphere. The encapsulation layer must be chemically stable, resist high temperatures and be impermeable to the atmosphere in order to perform its function as barrier layer. For example, the thin encapsulation layer consists of a polymer, a ceramic, a glass or a vitroceramic, capable of being, for example, in oxide, nitride, phosphate, oxynitride or siloxane form. Advantageously, this encapsulation layer includes a ceramic, glass or vitroceramic layer coated with an epoxy or silicone resin.

The encapsulation layer may advantageously be deposited by chemical vapor deposition (CVD), which makes it possible to provide coverage of all the accessible stack surfaces. Thus, the encapsulation may be performed directly on the stacks, the coating being capable of penetrating all of the available cavities. Advantageously, a second encapsulation layer may be deposited on the first encapsulation layer in order to increase the protection of the battery cells from the external environment. Typically, the deposition of said second layer may be performed by silicone impregnation. The choice of such a material is based on the fact that it is resistant to high temperatures and the battery may thus be easily assembled by welding on electronic cards without the appearance of glass transitions of the encapsulation materials.

Advantageously, the encapsulation of the battery is performed on four of the six faces of the stack. The encapsulation completely covers the surface of four of the six faces of the battery. The surfaces of the two remaining (opposite) faces of the battery are partially covered with at least one encapsulation layer, and the protection of the unprotected surfaces of said two faces is ensured by the terminals intended for the connections of the battery.

Preferably, the anode and cathode layers are laterally offset, enabling the encapsulation layer to cover the edges of the electrodes having the sign opposite that of the terminal. This encapsulation deposit on the edges of the electrodes not connected to the terminals makes it possible to prevent a short circuit at these ends.

Once the stack has been produced, and after the step of encapsulation of the stack if it is performed, terminals (electrical contacts) are added where the cathode or anode current collectors, respectively, are exposed (not coated with encapsulation layers). These contact zones may be on opposite sides of the stack in order to collect the current, but also on adjacent sides.

To produce the terminals, the stack, optionally coated, is cut according to cutting planes making it possible to obtain unitary battery components, with exposure on each of the cutting planes of connections (+) and (−) of the battery. The connections may then be metallized by means of plasma deposition techniques known to a person skilled in the art and/or by immersion in a conductive epoxy resin (filled with silver) and/or a molten tin bath. The terminals make it possible to establish alternately positive and negative electrical connections on each of the ends. These terminals make it possible to produce the electrical connections in parallel between the different battery elements. For this, only the (+) connections emerge at one end, and the (−) connections are available at the other ends.

As this battery is all-solid, and uses a lithium insertion material as the anode material, the risks of formation of metallic lithium dendrites during the recharging steps are zero and the capacity for insertion of the lithium anode becomes limited.

In addition, to ensure good cycling performance of the battery according to the invention, the battery architecture for which the surface capacity of the cathodes is greater than or equal to the surface capacity of the anodes is preferred.

As the layers forming the battery are all-solid, the risk of formation of lithium dendrites no longer exists when the anode is fully charged. Thus, such a battery architecture avoids the creation of an excess of battery cells.

In addition, the production of such a battery with cathode surface capacities greater than or equal to those of the anodes makes it possible to increase performance in terms of lifetime, expressed as a number of cycles. In fact, as the electrodes are dense and all-solid, the risk of loss of electrical contact between the particles is zero. Moreover, there is no longer a risk of metallic lithium deposit in the electrolyte or in the porosities of the electrodes, and finally there is no risk of deterioration of the crystalline structure of the cathode material.

### EXAMPLE

A suspension of the anode material was obtained by grinding then dispersion of Li4Ti5O12 in 10 g/l of absolute ethanol with several ppm of citric acid. A suspension of cathode material was obtained by grinding then dispersion of LiMn2O4 in 25 g/l of absolute ethanol. The cathode suspension was then diluted in acetone to a concentration of 5 g/l. The suspension of ceramic electrolyte material was obtained by grinding then dispersion of a powder of Li3Al0.4Sc1.6(PO4)3 in 5 g/l of absolute ethanol.

For all of these suspensions, the grindings were performed so as to obtain stable suspensions with particle sizes smaller than 100 nm.

The negative electrodes were prepared by electrophoretic deposition of the Li4Ti5O12 nanoparticles contained in the suspension previously prepared. The thin film of Li4Ti5O12 (around 1 micron) was deposited on the two faces of the substrate. These negative electrodes were then heat-treated at 600° C.

The positive electrodes were prepared in the same way, by electrophoretic deposition from the LiMn2O4 suspension. The thin film of LiMn2O4 (around 1 μm) was deposited on the two faces of the substrate. The positive electrodes were then treated at 600° C.

After the heat treatment, the negative electrodes and the positive electrodes were covered with a ceramic electrolyte layer Li3Al0.4Sc1.6(PO4)3 by electrophoretic deposition. The LASP thickness is around 500 nm on each electrode. These electrolyte films were then dried.

The stack of Li3Al0.4Sc1.6(PO4)3 coated anodes and cathodes was then produced in order to obtain a multilayer stack. The assembly was then kept under pressure for 15 minutes at 600° C. in order to produce the assembly.

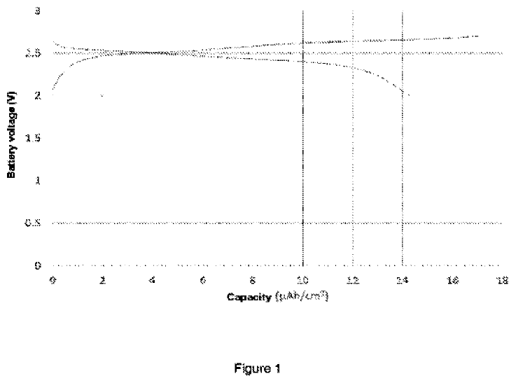

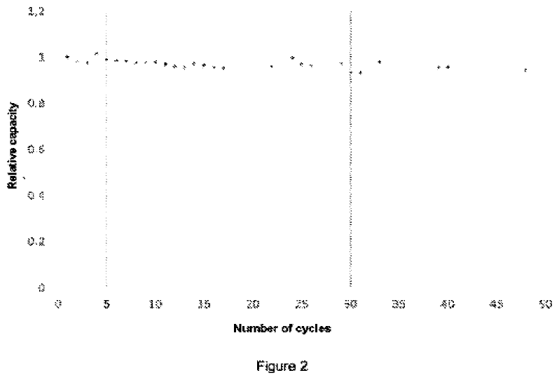

The battery thus obtained was cycled between 2 and 2.7 V. FIG. 1 shows the charge and discharge curves obtained with this battery. FIG. 2 shows the change in the capacity of the battery thus produced during cycling.

What is claimed is:

1. A process for producing an all-solid, thin-layer battery, the process comprising:
a) producing an anode material layer by depositing at least one anode material on a first conductive substrate selected from a group formed by a metal sheet, a metal strip, a metallized insulating sheet, a metallized insulating strip, or a metallized insulating film, wherein said first conductive substrate, or conductive elements thereof, is configured to serve as an anode current collector;
b) producing a cathode material layer by depositing at least one cathode material on a second conductive substrate selected from a group formed by a metal sheet, a metal strip, a metallized insulating sheet, a metallized insulating strip, or a metallized insulating film, wherein said conductive substrate, or conductive elements thereof, is configured to serve as a cathode current collector;
c) producing an electrolyte material layer by depositing at least one solid electrolyte material on the anode material layer and/or on the cathode material layer, the at least one solid electrolyte material being chosen from:
Li₁₊ₓM2ₓ(Sc)₂₋ₓ(PO₄)₃ with M2=Al, Y, Ga or a mixture thereof, and 0≤x≤0.8; or
Li₁₊ₓM3ₓ(Ga_{1-y}Sc_{y})₂₋ₓ(PO₄)₃ with 0≤x≤0.8; 0≤y≤1 and M3=Al or Y; or a mixture thereof; or
Li_{3+y}(SC₂₋ₓM5ₓ)Q_{y}P_{3-y}O₁₂ with M5=Al and/or Y and Q=Si and/or Se, 0≤x≤0.8 and 0<y≤1; or
Li_{1+x+y}M6ₓSC₂₋ₓQ_{y}P_{3-y}O₁₂ with M6=Al, Y, Ga or a mixture thereof, and Q=Si and/or Se, 0≤x≤0.8 and 0≤y≤1; or
Li_{1+x+y+z}M7ₓ(Ga_{1-y}Sc_{y})₂₋ₓQ_{Z}P_{3-z}O₁₂ with 0≤x≤0.8; 0≤y≤1; 0≤z≤0.6 with M7=Al or Y or a mixture thereof, and Q=Si and/or Se; or
Li₁₊ₓN1ₓM8₂₋ₓP₃O₁₂ with 0≤x≤1 and N1=Cr and/or V, M8=Sc, Sn, Zr, Hf, Se or Si, or a mixture thereof;
d) stacking, layer upon layer, in series:
the anode material layer coated with the electrolyte material layer obtained in c), with the cathode material layer uncoated or coated with the at least one electrolyte material layer obtained in c); or
the cathode material layer coated with the at least one electrolyte material layer obtained in c), with the anode material layer uncoated or coated with the at least one electrolyte material layer obtained in c);
e) performing a heat treatment and/or a mechanical compression on the stack obtained in d) in order to obtain the all-solid, thin-layer battery.

2. The process of claim 1, further comprising, when the electrolyte material layer is deposited on the anode material layer, depositing, on the cathode material layer, a layer composed of at least one material chosen from the following:
Li₃(Sc₂₋ₓM9ₓ)(PO₄)₃ with M9=Al or Y and 0≤x≤1; or
Li₁₊ₓM10ₓ(Sc)₂₋ₓ(PO₄)₃ with M10=Al, Y, Ga or a mixture of two or three compounds thereof, and 0≤x≤0.8; or
Li₁₊ₓM11ₓ(Ga_{1-y}Sc_{y})₂₋ₓ(PO₄)₃ with 0≤x≤0.8; 0≤y≤1 and M11=Al or Y; or a mixture thereof; or
Li₁₊ₓAlₓTi₂₋ₓ(PO₄)₃ with 0≤x≤1; or
Li_{1+x+z}M12ₓ(Ge_{1-y}Ti_{y})₂₋ₓSi_{z}P_{3-z}O₁₂ with 0≤x≤0.8; 0≤y≤1; 0≤z≤0.6 and M12=Al, Ga, or Y or a mixture of two or three compounds thereof; or
Li_{3+y}(SC₂₋ₓM13ₓ)Q_{y}P_{3-y}O₁₂, with M13=Al and/or Y and Q=Si and/or Se, 0≤x≤0.8 and 0≤y≤1; or
Li_{1+x+y}M14ₓSC₂₋ₓQ_{y}P_{3-y}O₁₂ with M14=Al, Y, Ga or a mixture thereof, and Q=Si and/or Se, 0≤x≤0.8 and 0≤y≤1; or
Li_{1+x+y+z}M15ₓ(Ga_{1-y}SC_{y})₂₋ₓQ_{z}P_{3-z}O₁₂ with 0≤x≤0.8; 0≤y≤1; or 0≤z≤0.6 with M15=Al or Y or a mixture thereof, and Q=Si and/or Se;
Li₁₊ₓN2ₓM16₂₋ₓP₃O₁₂ with 0≤x≤1 and N2=Cr and/or V, M16=Sc, Sn, Zr, Hf, Se or Si or a mixture thereof.

3. The process of claim 1, wherein the anode material layer, the cathode material layer, and the electrolyte material layer are deposited using at least one of the following:
(i) vacuum evaporation, laser ablation, ion beam, or cathode sputtering;
(ii) plasma-enhanced chemical vapor deposition (PECVD), laser-assisted chemical vapor deposition (LACVD), or aerosol-assisted chemical vapor deposition (AA-CVD);
(iii) electrospraying;
(iv) electrophoresis;
(v) aerosol deposition;
(vi) sol-gel;
(vii) dip-coating, spin-coating or the Langmuir-Blodgett process.

4. The process of claim 1, wherein the anode material layer, the cathode material layer, and the electrolyte material layer are deposited by electrophoresis.

5. The process of claim 1, wherein the anode material layer, the cathode material layer, and the electrolyte material layer respectively include graphite and/or nanoparticles of lithium ion conducting materials, of the type used to produce electrolyte films or cross-linked solid polymer materials comprising ionic groups.

6. The process of claim 1, wherein:
producing the anode material layer comprises depositing nanoparticles of the at least one anode material using electrophoresis; and/or
producing the cathode material layer comprises depositing nanoparticles of the at least one cathode material using electrophoresis; and/or
producing the electrolyte material layer comprises depositing nanoparticles of the at least one electrolyte material using electrophoresis.

7. The process of claim 6, wherein the nanoparticles of the at least one electrolyte material have a size less than 30 nm.

8. The process of claim 1, wherein the at least one anode material layer is produced from an anode material chosen from:
(i) tin oxynitrides;
(ii) lithiated iron phosphate;
(iii) mixed silicon and tin oxynitrides SiₐSn_{b}O_{y}N_{z} with a>0, b>0, a+b≤2, 0<y≤4, 0<z≤3; SiSn_{0.87}O_{1.2}N_{1.72}, oxynitrides SiₐSn_{b}C_{c}O_{y}N_{z}, with a>0, b>0, a+b≤2, 0<c<10, 0<y<24, 0<z<17, SiₐSn_{b}C_{c}O_{y}N_{z}Xₙ with Xₙ at least one of the elements among F, Cl, Br, I, S, Se, Te, P, As, Sb, Bi, Ge, Pb and a>0, b>0, a+b>0, a+b≤2, 0<c<10, 0<y<24 and 0<z<17, and SiₐSn_{b}O_{y}N_{z}Xₙ with Xₙ at least one of the elements among F, Cl, Br, I, S, Se, Te, P, As, Sb, Bi, Ge, Pb and a>0, b>0, a+b≤2, 0<y≤4 and 0<z≤3;
(iv) nitrides SiₓN_{y} (with x=3 and y=4), SnₓN_{y} (with x=3 and y=4), and ZnₓN_{y} (with x=3 and y=4); and
(v) oxides SnO₂, Li₄Ti₅O₁₂, SnB_{0.6}P_{0.4}O_{2.9} and TiO₂.

9. The process of claim 1, wherein the at least one cathode material layer is produced from a cathode material chosen from:
(i) LiMn₂O₄, LiCoO₂, LiNiO₂, LiMn_{1.5}Ni_{0.5}O₄, LiMn_{1.5}Ni_{0.5-x}XₓO₄ (in which X is selected from Al, Fe, Cr, Co, Rh, Nd, other rare earth elements, and in which 0<x<0.1), LiFeO₂, LiMn_{1/3}Ni_{1/3}Co_{1/3}O₄;
(ii) LiFePO₄, LiMnPO₄, LiCoPO₄, LiNiPO₄, Li₃V₂(PO₄)₃; phosphates in the form of LiM17M18PO₄, with M17≠M18, and M17 and M18 selected from Fe, Mn, Ni, Co, V;
(iii) all lithiated forms of chalcogenides V₂O₅, V₃O₈, TiS₂, titanium oxysulfides tungsten oxysulfides CuS, CuS₂.

10. The process of claim 1, further comprising, after performing e):
f) encapsulating the all-solid, thin-film battery by depositing at least one layer of a ceramic material, a vitreous material, or a vitroceramic material.

11. The process of claim 10, further comprising, after performing f):
cutting at least two faces of the encapsulated all-solid, thin-film battery so as to expose only the solid cathode on a first cutting plane, and only the solid anode on a second cutting plane.

12. A process for producing an all-solid, thin-layer battery, the process comprising:
a) producing an anode material layer by depositing at least one anode material on a first conductive substrate, wherein said first conductive substrate, or conductive elements thereof, is configured to serve as an anode current collector;
b) producing a cathode material layer by depositing at least one cathode material on a second conductive substrate, wherein said conductive substrate, or conductive elements thereof, is configured to serve as a cathode current collector;
c) producing an electrolyte material layer by depositing at least one solid electrolyte material on the anode material layer and/or on the cathode material layer, the at least one solid electrolyte material being chosen from:
Li₁₊ₓM2ₓ(Sc)₂₋ₓ(PO₄)₃ with M2=Al, Y, Ga or a mixture thereof, and 0≤x≤0.8; or
Li₁₊ₓM3ₓ(Ga_{1-y}Sc_{y})₂₋ₓ(PO₄)₃ with 0≤x≤0.8; 0≤y≤1 and M3=Al or Y; or a mixture thereof; or
Li_{3+y}(SC₂₋ₓM5ₓ)Q_{y}P_{3-y}O₁₂ with M5=Al and/or Y and Q=Si and/or Se, 0≤x≤0.8 and 0<y≤1; or
Li_{1+x+y}M6ₓSC₂₋ₓQ_{y}P_{3-y}O₁₂ with M6=Al, Y, Ga or a mixture thereof, and Q=Si and/or Se, 0≤x≤0.8 and 0≤y≤1; or
Li_{1+x+y+z}M7ₓ(Ga_{1-y}Sc_{y})₂₋ₓQ_{Z}P_{3-z}O₁₂ with 0≤x≤0.8; 0≤y≤1; 0≤z≤0.6 with M7=Al or Y or a mixture thereof, and Q=Si and/or Se; or
Li₁₊ₓN1ₓM8₂₋ₓP₃O₁₂ with 0≤x≤1 and N1=Cr and/or V, M8=Sc, Sn, Zr, Hf, Se or Si, or a mixture thereof;
d) stacking, layer upon layer, in series:
the anode material layer coated with the electrolyte material layer obtained in c), with the cathode material layer uncoated or coated with the at least one electrolyte material layer obtained in c); or
the cathode material layer coated with the at least one electrolyte material layer obtained in c), with the anode material layer uncoated or coated with the at least one electrolyte material layer obtained in c);
e) performing a heat treatment and/or a mechanical compression on the stack obtained in d) in order to obtain the all-solid, thin-layer battery.

13. An all-solid, thin-film battery, producing in accordance with the process of claim 1.

14. The all-solid, thin-film battery of claim 13, wherein a surface capacity of the solid cathode is greater than or equal to a surface capacity of the solid anode.

15. The all-solid, thin-film battery of claim 13, wherein a stack of the solid cathode is laterally offset to a stack of the solid anode.

16. The all-solid, thin-film battery of claim 13, further comprising at least one first encapsulation layer composed of a ceramic material, a vitreous material, or a vitroceramic material.

17. The all-solid, thin-film battery of claim 16, further comprising a second encapsulation layer on the at least one first encapsulation layer, the second encapsulation layer being composed of silicone.

18. The all-solid, thin-film battery of claim 17, wherein said at least one first encapsulation layer entirely covers four of six faces of said all-solid, thin-film battery, and partially covers two remaining faces located below metallizations for connection of the all-solid, thin-film battery.

19. The all-solid, thin-film battery of claim 13, wherein the all-solid, thin-film battery is entirely inorganic.
